(19) United States
(12) Patent Application Publication
(10) Pub. No.: US 2016/0006500 A1
(43) Pub. Date: Jan. 7, 2016

(54) SATELLITE PACKET NETWORK FOR CELLULAR BACKHAUL OF ACCESS POINT DEVICES

(71) Applicant: AT&T Intellectual Property I, L.P., Atlanta, GA (US)

(72) Inventor: Assad Radpour, Austin, TX (US)

(21) Appl. No.: 14/322,123

(22) Filed: Jul. 2, 2014

(51) Int. Cl. H04B 7/185; H04W 72/08; H04L 5/00; H04W 28/02

(52) U.S. Cl. CPC H04B 7/18539; H04W 28/0278; H04W 72/085; H04L 5/0007

(57) ABSTRACT

Communication services can be provided through utilization of wireless access points that are connected to the core network (e.g., evolved packet core (EPC) of a Long Term Evolution LTE cellular system) via a set of satellite links. The efficiency of the satellite space segment is increased by employing an Orthogonal Frequency Division Multiple Access (OFDMA) and a scheduling scheme based on traffic demand, satellite channel conditions, and/or Quality of Service (QoS) requirement of a data flow. The satellite space segment is shared between all the wireless access points in the satellite's footprint, in a time and spectrally efficient manner, wherein the spectrum is used by a given wireless access point only when the wireless access point needs to transmit or receive packet data but otherwise is available to other wireless access points.

### TECHNICAL FIELD

The subject disclosure relates to wireless communications, e.g., to a satellite packet network for cellular backhaul of access point devices.

### BACKGROUND

As applications and utilization of mobile communication continues to grow rapidly, mobile telecommunications carriers are seeing an increase in demand for communication services in low density, rural, and hard-to-reach areas. Challenges to meet these demands and provide telecommunication services in such areas are driven by both technological and economic considerations. Provisioning of mobile communication services to end users through wireless access technologies requires landline facilities to serve the wireless terminals and base stations deployed within the areas. Conventional systems typically utilize metallic or fiber optic landlines as backhaul links that extend buried underground cable facilities to the customer premises as well as to central offices and remote optical terminals. Other conventional systems have utilized point-to-point (PTP) microwave links for backhauling the terminal traffic to the core network. However, these backhaul solutions have high installation and operational costs associated with them.

### BRIEF DESCRIPTION OF THE DRAWINGS

FIG. 1 illustrates an example system comprising a set of wireless access points deployed within a satellite's footprint that provide communication services to a set of user equipment (UE) through a cellular system having distributed base stations.

FIG. 2 illustrates an example system for providing communication services via satellite backhaul links.

FIG. 3 illustrates an example system that assigns satellite channels to wireless access points to optimize satellite spectrum utilization.

FIG. 4 illustrates an example system comprising a satellite that schedules data transmissions transmitted to/from wireless access points via satellite backhaul links.

FIG. 5 illustrates an example system that is utilized to increase capacity and spectral efficiency of a satellite backhaul channel.

FIGS. 6A-6B illustrate example systems that facilitate automating one or more features in accordance with the subject embodiments.

FIG. 7 illustrates an example method for modulating a signal transmitted between a satellite and one or more wireless access points.

FIG. 8 illustrates an example method that facilitates scheduling satellite links between a satellite and a set of wireless access points.

FIG. 9 illustrates an example block diagram of a satellite suitable for scheduling and/or modulating signals transmitted via wireless backhaul links.

FIG. 10 illustrates a Long Term Evolution (LTE) network architecture that can employ the disclosed architecture.

FIG. 11 illustrates a block diagram of a computer operable to execute the disclosed communication architecture.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details, e.g., without applying to any particular networked environment or standard. In other instances, well-known structures and devices are shown in block diagram form in order to facilitate describing the embodiments in additional detail.

As used in this application, the terms “component,” “module,” “system,” “interface,” “node,” “platform,” “point,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment,” “mobile station,” “mobile device,” “mobile terminal,” and similar terminology, refer to a wired or wireless device utilized by a subscriber or user of a wired or wireless communication service to receive or convey data, control, voice, video, sound, gaming, or substantially any data-stream or signaling-stream. The foregoing terms are utilized interchangeably in the subject specification and related drawings. Data and signaling streams can be packetized or frame-based flows. Furthermore, the terms “user,” “subscriber,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

The systems and methods disclosed herein provide voice over Internet protocol (VoIP), Internet/broadband access, and/or internet protocol (IP) services for subscribers (e.g., using mobile devices, such as, but not limited to cellular phones, tablet computers, e-readers, laptops, etc.) located in remote and/or out-of-reach areas as well as on airborne or seaborne vessels and platforms (e.g., airplane, ship, vehicle, train, etc.) through utilization of wireless terminals or cellular access points (e.g., Long Term Evolution (LTE) eNodeB base stations) that are connected to the core network (e.g., evolved packet core (EPC)) via satellite links. Further, this disclosure describes a satellite access method based on Orthogonal Frequency Division Multiple Access (OFDMA) and a scheduling scheme for utilization of the scarce satellite space segment in more spectrally efficient packet mode to backhaul the traffic from one or more user equipment (UE) and access points to the network core.

In one aspect, the disclosed systems provide high-speed IP broadband services to the UE using the 4G/LTE mobile IP services through wireless access points that are backhauled from the satellite links in a packet access mode. Accordingly, installation, operational, and/or maintenance costs associated with extending the metallic or fiber optic landlines to the end user, wireless access points, central offices, or remote optical terminals, can be eliminated. The scarce satellite space segment is shared between all the wireless access points in satellite's footprint, in a spectrally efficient manner, wherein the spectrum is used by a given wireless access point only when the wireless access point needs to transmit or receive data but otherwise is available to other UEs and/or wireless access points. The spectrum can be assigned in multiple time slots based on the required amount of bandwidth and/or prevailing satellite channel conditions (e.g., cloud cover, weather conditions, etc.).

As an example, aspects or features of the disclosed subject matter can be exploited in substantially any wired or wireless communication technology; e.g., Universal Mobile Telecommunications System (UMTS), WiFi, Worldwide Interoperability for Microwave Access (WiMAX), General Packet Radio Service (GPRS), Enhanced GPRS, Third Generation Partnership Project (3GPP) LTE, Third Generation Partnership Project 2 (3GPP2) Ultra Mobile Broadband (UMB), High Speed Packet Access (HSPA), Zigbee, or another IEEE 802.XX technology. Additionally, substantially all aspects of the disclosed subject matter can be exploited in legacy (e.g., wireline) telecommunication technologies and/or future telecommunication technologies (e.g., 5G, whitespace, etc.).

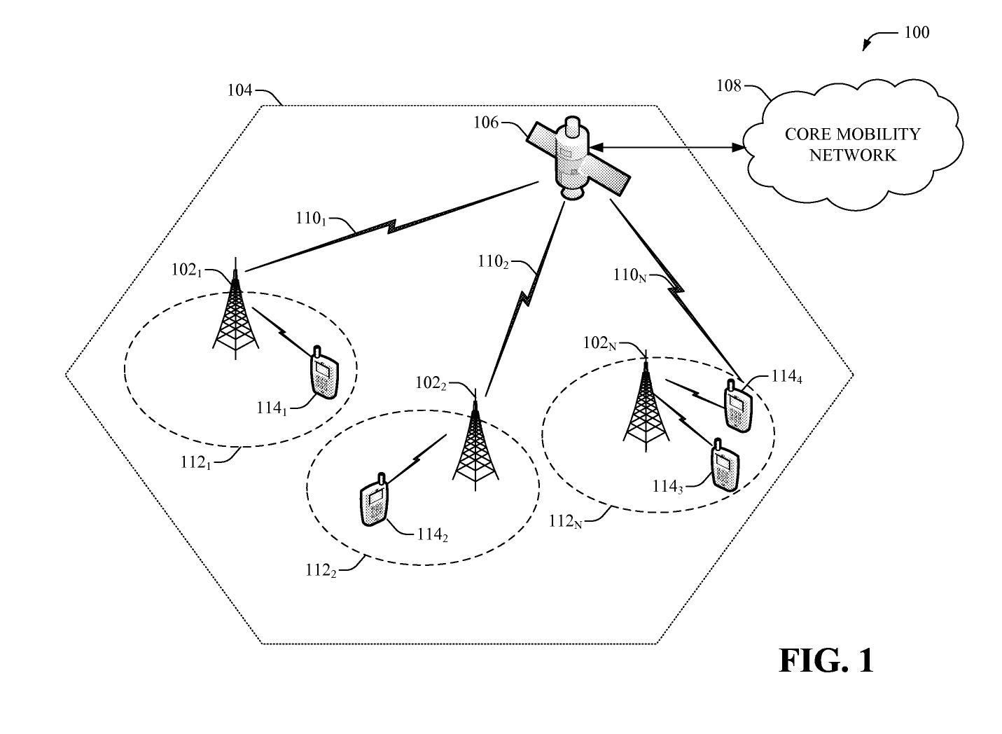

Referring initially to FIG. 1, there illustrated is an example system 100 comprising a set of wireless access points deployed within a satellite's footprint that provide communication services to a set of UE, according to one or more aspects of the disclosed subject matter. Provisioning of mobile communication services (e.g., Internet, wireless services, high speed IP broadband, etc.) and/or voice communications to low density, rural, and/or hard-to-reach areas had been considered by using wired landlines that would extend buried underground cable facilities to customer premises as well as to central offices and/or remote optical terminals. However, costs associated with installation, operation, and/or maintenance of wired landlines can be extremely high. System 100 provides a cost effective infrastructure to provision mobile communication services and/or voice communications using wireless access points 102₁-102_{N} (wherein N is most any positive integer). In one aspect, the wireless access points 102₁-102_{N} can be deployed within a footprint (e.g., coverage area) 104 of a satellite 106. As an example, the satellite 106 can include, but is not limited to, a low earth orbit (LEO) satellite, a middle earth orbit (MEO) satellite, a geostationary earth orbit (GEO) satellite, etc.

In one aspect, the satellite 106 couples the wireless access points 102₁-102_{N} to the core mobility network 108 (e.g., EPC) via one or more wireless links 110₁-110_{N}. As an example, the wireless links 110₁-110_{N} can share satellite spectrum in a packet access mode. Moreover, spectral efficiency can be increased by modulating the signals transmitted via the wireless links 110₁-110_{N} based on orthogonal frequency division multiple access (OFDMA). Further, using a scheduler (e.g., of the satellite 106 or a network device of the core mobility network 108), the spectrum allocation can be performed based on traffic requested by wireless access points 102₁-102_{N}, Quality of Service (QoS) requirements associated with data that is transmitted via the wireless links 110₁-110_{N}, and/or the satellite channel conditions (e.g., cloud cover/weather conditions between the satellite 106 and the wireless access points 102₁-102_{N}). Accordingly, the satellite spectrum is utilized by a specific wireless access point (e.g., 102₁) only when the wireless access point needs to transmit and/or receive data, but otherwise is available to other wireless access points (e.g., 102₂ and/or 102_{N}) for data transfers. Additionally or optionally, to further increase the capacity and/or spectral efficiency of the satellite channel, multiple satellite spot beams can be utilized by the satellite 106, wherein the spectrum is re-used within the region covered by each satellite spot beam.

As an example, the wireless access points 102₁-102_{N} deployed within the satellite footprint 104 can include (and/or operate substantially similar to), but are not limited to, a base station, an eNodeB, a pico station, a WiFi access point, a femto access point, a HomeNodeB, etc. Moreover, the wireless access points 102₁-102_{N} can be stationary and/or mobile, for example, deployed on an aircraft, train, and/or ship. The coverage areas 112₁-112_{N} of the wireless access points 102₁-102_{N} typically cover an area that is determined, at least in part, by transmission power allocated to the respective wireless access points 102₁-102_{N}, path loss, shadowing, and so forth. Although depicted as elliptical, it is noted that the coverage areas 112₁-112_{N} can include most any shape (e.g., irregular or non-geometrical). As a UE, e.g., UE 114₁-114₄, enters a coverage area (e.g., areas 112₁-112_{N}), the UE can attempt to attach to a serving wireless access point (e.g., 102₁-102_{N}) through transmission and reception of attachment signaling. When an attachment attempt is successful, the UE can be allowed to connect to the wireless access point (e.g., 102₁-102_{N}) and voice and/or data traffic associated with the UE can be paged and routed to the core mobility network 108 via satellite 106. It is to be noted that as the wireless access point (e.g., 102₁-102_{N}) generally can rely on satellite backhaul links (e.g., 110₁-110_{N}) for routing and signaling, and for packet communication, substantially any quality of service can handle heterogeneous packetized traffic. Namely, packet flows established for wireless communication devices (e.g., UE 114₁-114₄) served by the wireless access point (e.g., 102₁-102_{N}). It is to be noted that to ensure a positive subscriber experience, or perception, it is desirable for the wireless access point (e.g., 102₁-102_{N}) to maintain a high level of throughput for traffic (e.g., voice and data) utilized on a wireless communication device for one or more subscribers while in the presence of external, additional packetized, or broadband, traffic associated with applications (e.g., web browsing, data transfer (e.g., content upload), and the like) executed in devices within the access point coverage area (e.g., 112₁-112_{N}).

In one aspect, the air interface utilized by the wireless access points 102₁-102_{N} can be the same as (or substantially similar to) a wireless access point (not shown) that utilizes a wired backhaul link. Accordingly, a user can employ most any off-the-shelf internet access and/or telephone device (e.g., UE 114₁-114₄). As an example, the UEs 114₁-114₄ can include most any electronic communication devices such as, but not limited to, a consumer electronic device, for example, a tablet computer, a digital media player, a digital photo frame, a digital camera, a cellular phone, a personal computer, a personal digital assistant (PDA), a smart phone, a laptop, a gaming system, etc. Further, UEs 114₁-114₄ can also include, LTE-based devices, such as, but not limited to, most any home or commercial appliance that includes an LTE radio. As an example, the LTE-based devices can perform machine-to-machine (M2M) and Internet of Things (IoT) communication, for various applications, such as (but not limited to) for oil drilling/flow control or irrigation systems (e.g., far away from roads or located in the middle of a desert/ocean and/or agricultural fields). Further, it is noted that UEs 114₁-114₄ can be mobile, have limited mobility and/or be stationary. As an example, UEs 114₁-114₄ can be devices that are part or coupled to a vehicle (e.g., connected cars). In one example, UEs 114₁-114₄ can include a multi-band, multi-mode, and/or multi-radio device. Although only four UEs 114₁-114₄ are depicted in FIG. 1, it can be noted that more or less number of UEs can be coupled to respective wireless access points 102₁-102_{N}.

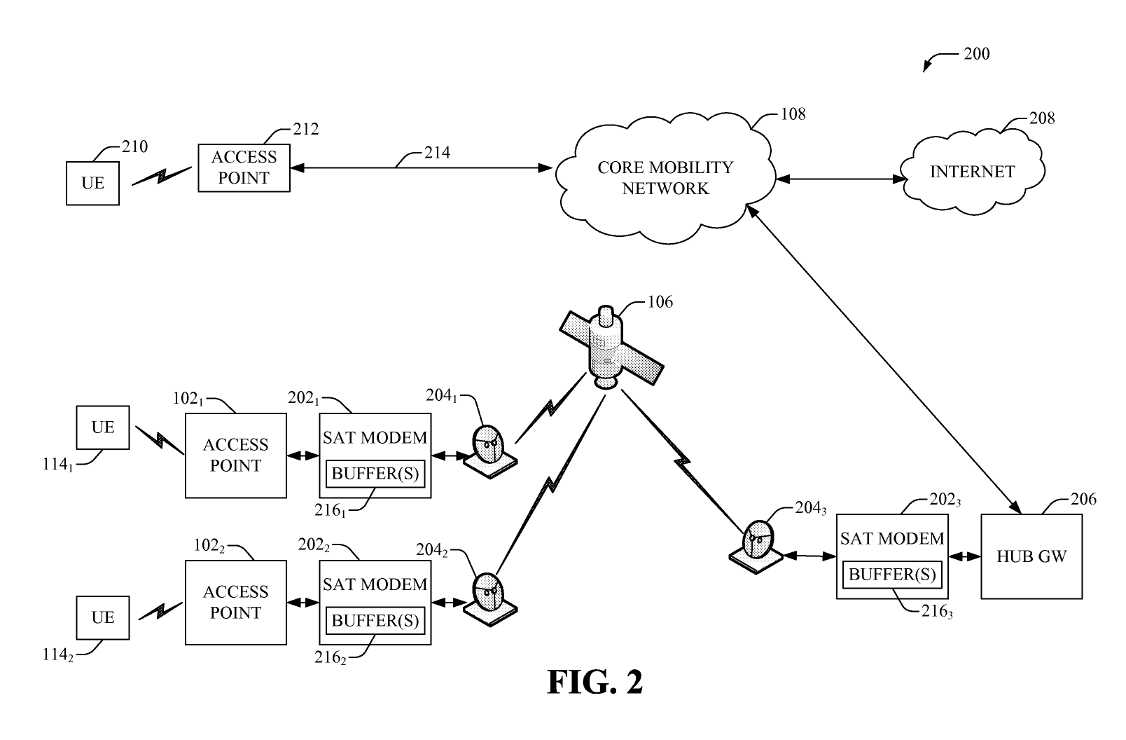

Referring now to FIG. 2, there illustrated is an example system 200 for providing communication services via satellite backhaul links, in accordance with an aspect of the subject disclosure. In one aspect, system 200 facilitates sharing satellite spectrum between a set of wireless access points (e.g., 102₁-102₂) such that the spectrum is utilized by/allocated to a particular wireless access point only when the wireless access point is communicating via the satellite 106. It is noted that the wireless access points 102₁-102₂ can be most any access points, such as but not limited to a macro access point, a femto access point, a pico station, etc. and can include functionality as more fully described herein, for example, as described above with regard to system 100. Further, it is noted that the satellite 106 and the core mobility network 108 can include functionality as more fully described herein, for example, as described above with regard to system 100. System 200 reduces costs associated with wired backhaul links for access points deployed in rural, low density, hard to reach locations, and/or on airborne and/or seaborne vessels and/or platforms. Further, system 200 maximizes spectrum utilization of the satellite spectrum utilized for backhaul.

According to an embodiment, wireless access points 102₁-102₂ can be coupled to satellite modems 202₁-202₂ which in turn are coupled to antennas 204₁-204₂ (e.g., dish antennas) that facilitate packet switched communication with the satellite 106. As an example, communication data is transparently tunneled from the access points 102₁-102₂ to the core mobility network 108, for example using a GPRS Tunneling Protocol (GTP) or a Generic Routing Encapsulation (GRE) protocol or IPSec (Internet Protocol Security). In one aspect, the hub gateway 206 and/or satellite modems 202₁-202₃ can include tunnel termination functionality for a tunnel having the hub gateway 206 and/or satellite modems 202₁-202₃ as endpoints. Although depicted as residing outside the wireless access points 102₁-102₂, it can be noted that the satellite modems 202₁-202₂ and/or antennas 204₁-204₂ can be part of and completely or partially reside within the wireless access points 102₁-102₂. In one aspect, a satellite modem (e.g., 202₁-202₂) can perform modulation/demodulation of signals transmitted between the satellite 106 and a wireless access point (e.g., 102₁-102₂). In one example, OFDMA is utilized for the multiple access/modulation/demodulation to increase efficiency of the satellite spectrum usage. Additionally or optionally, OFDMA can be utilized in conjunction with advanced antenna techniques and adaptive modulation and coding to achieve significant throughput and satellite spectral efficiency improvements. The increased satellite spectral efficiency facilitates transfer of data at a higher rate per a given bandwidth, resulting in a lower cost-per-bit.

Further, the satellite modem (e.g., 202₁-202₃) can include a buffer (e.g., 216₁-216₃) that stores data received from the wireless access point (e.g., 102₁-102₂) (or hub gateway 206), for example, aggregated data received from (or transmitted to) one or more UEs (e.g., 114₁-114₂) served by the wireless access point (e.g., 102₁-102₂). Based on the data currently in its buffer 216₁-216₃ (e.g., transmit buffer), the satellite modem (e.g., 202₁-202₂) can request for satellite resource allocation including allocation of bandwidth and time slots. Accordingly, if the buffer is empty, satellite resources are not allocated to the satellite modem and can be used by other satellite modems that are transmitting/receiving data. In another example, if a transmit/receive buffer 216₁ associated with satellite modem 202₁ has more data than the buffer 216₂ associated with satellite modem 202₂, a larger amount of satellite resources (e.g., bandwidth and/or time slots) can be allocated to satellite modem 202₁ than that allocated to satellite modem 202₂.

In one aspect, the satellite 106 can relay information (e.g., voice and/or data communications) received from the wireless access points 102₁-102₂ via satellite modems 202₁-202₂ and antennas 204₁-204₂, to a hub gateway 206 that is coupled to (or part of) a core mobility network 108 (e.g., the LTE EPC). Moreover, the hub gateway 206 receives the information via a satellite modem 202₃ and antenna 204₃ (e.g., dish antenna) and transmits the information to core mobility network 108 which can then direct the information to a destination device, for example, via the Internet 208 or to a UE 210 coupled to an access point 212 (e.g., macro access point, femto access point, pico station, WiFi access point, etc.) that is coupled to the core mobility network 108 via wired backhaul link 214 (e.g., optical fiber backbone, twisted-pair line, T1/E1 phone line, DSL, or coaxial cable). Similarly, information (e.g., voice and/or data communications) received from a source device, for example, via the Internet 208 or a UE 210 that is directed to the UEs 114₁-114₂ and/or wireless access points 102₁-102₂, can be transmitted from the core mobility network 108 to the hub gateway 206. The satellite modem 202₃ at the hub gateway 206 can modulate the information (e.g., by employing OFDMA, Phase-shift keying (PSK), Quadrature amplitude modulation (QAM), etc.) and transmit the information to satellite 106 via antenna 204₃. The satellite 106 can relay the information to the destination device via a satellite backhaul link.

In one aspect, the information transmitted between the satellite 106 and antennas 204₁-204₃ can be scheduled on the satellite-to-access point link based on traffic demand and/or Quality of Service (QoS) requirements of a Media Access Control (MAC) layer. As an example, the satellite modems 202₁-202₂ can include, but are not limited to, a very small aperture terminal (also known as VSAT). In one aspect, the satellite modems 202₁-202₂ can comprise a satellite ground station that can include transmit and receive units and the associated buffers (e.g., buffers 216₁-216₃), and the protocol stack to handle the satellite link PHY and MAC layers. Further, with the satellite modems 202₁-202₂ can include or be coupled to a dish antenna that communicates with satellite(s) in geosynchronous orbit (or other orbits) to transmit/receive packetized data. The satellite modem 202₃ can generally have a larger dish antenna and can use OFDM techniques for attaining higher spectral efficiency as opposed to pure multiple access purposes. The satellite modems 204₁-204₃ can be utilized to couple a wireless access point (e.g., 102₁-102₂) and/or the hub gateway (e.g., 206) to a satellite 106 via a wireless backhaul link. In another example, satellite modems 202₁-202₃ can include, but are not limited to, a Base Station Satellite Modem (BSSM) and/or a Base Station Satellite Transceiver (BSSTX) that can utilize an Inverse Fast Fourier Transform/Fast Fourier Transform (IFFT/FFT) for an implementation that increases efficiency and cost optimization. The connection between the hub gateway 206 and the core mobility network 108 can be through dedicated lines or public IP access with the use of secure tunnels.

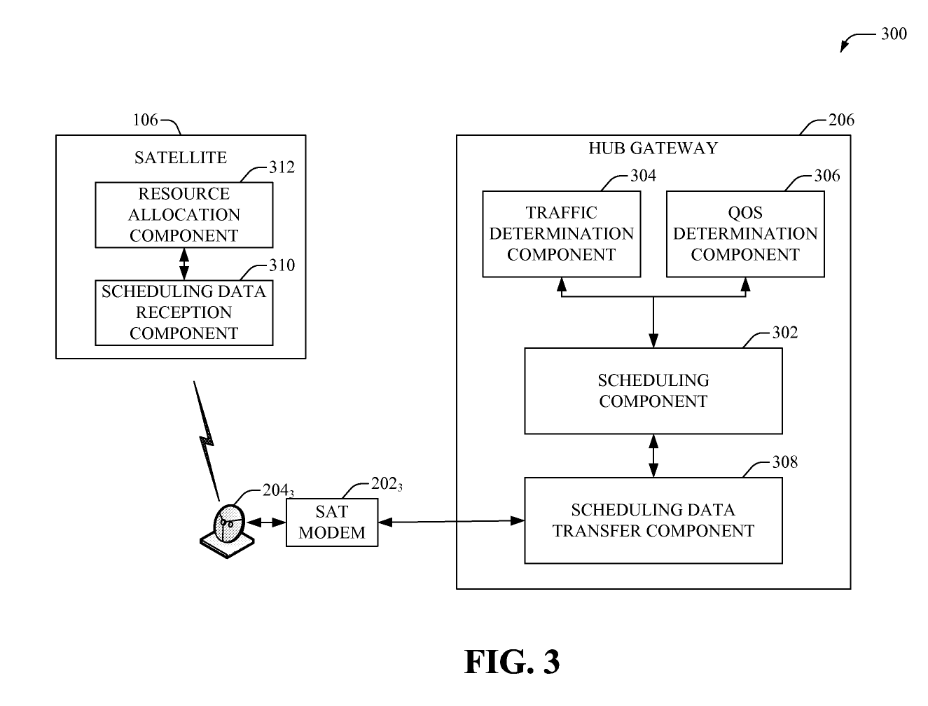

Referring now to FIG. 3, there illustrated is an example system 300 that assigns satellite channels to wireless access points (e.g., 102₁-102₃) to optimize satellite spectrum utilization, according to an aspect of the subject disclosure. It is noted that the satellite 106, the hub gateway 206, satellite modem 202₃, and antenna 204₃ can include functionality as more fully described herein, for example, as described above with regard to systems 100 and 200. System 300 includes a hub gateway 206 that schedules data transmissions between the satellite and the wireless access points via the satellite backhaul links (e.g., 110₁-110_{N}). In one aspect, hub gateway 206 comprises a scheduling component 302 that schedules the data transmissions based on traffic requested by the wireless access points and/or QoS requirements of the traffic and/or the satellite channel quality (e.g., obstacles, weather conditions, cloud cover, etc.).

A traffic determination component 304 can be utilized to determine an amount of data that is to be transmitted between the satellite 106 and each wireless access point (e.g., 102₁-102₃). In one aspect, the traffic determination component 304 can identify the amount of traffic requested by each wireless access point (e.g., 102₁-102₃) based on control signaling received from the wireless access points (e.g., 102₁-102₃). For example, the traffic determination component 304 can receive control information from a wireless access point (e.g., 102₁-102₃) and/or the hub gateway 206 indicative of data that is to be transmitted/received by that wireless access point (e.g., buffer status report indicative of amount of data stored in a buffer of the wireless access point and/or buffer (e.g., 216₁-216₃) of a satellite modem coupled to the wireless access point). The scheduling component 302 can allocate more resources (e.g., bandwidth/spectrum, time slot, etc.) to a wireless access point that is determined to be transmitting/receiving greater amount of data and fewer resources (e.g., bandwidth/spectrum, time slot, etc.) to a wireless access point that is determined to be transmitting/receiving less amount of data.

Additionally or alternatively, a QoS determination component 306 can be utilized to determine a QoS classification of traffic that is to be transmitted between the satellite 106 and each wireless access point (e.g., 102₁-102₃). QoS specifies a priority associated with a transmission of the traffic between the satellite 106 and a wireless access point whilst meeting a combination of latency, jitter, error rate and maximum/guaranteed bit rate requirements. In one example, the QoS associated with the traffic can be determined based on a QoS Class Identifier (QCI) that provides information regarding priority and/or type of service. For instance, a higher QoS priority can be assigned to traffic associated with real-time communication (e.g., video calls, interactive gaming, etc.) compared to a QoS priority assigned to traffic associated with non real-time communication (e.g., email, messaging, etc.). Further, a higher QoS priority can be assigned to traffic associated with a UE or wireless access point (e.g., femto access point) of a subscriber that has paid a higher fee to obtain a higher QoS. The scheduling component 302 can allocate resources (e.g., bandwidth/spectrum, time slot, etc.) for a traffic flow based on its assigned QoS; for example, a larger amount of resources can be allocated to a traffic flow that has a higher QoS priority than a traffic flow that has a lower QoS priority. Additionally or optionally, appropriate amount of satellite channel resources can be scheduled based on the reported (e.g., by the wireless access point 102₁-102₃) quality of the satellite channel to combat, for example, the adverse atmospheric conditions.

According to an embodiment, the scheduling component 302 can facilitate scheduling in the frequency and time domain. For example, different carriers or sub-carriers can be scheduled to different wireless access points based on utilization of OFDMA in the downlink (e.g., from the satellite 106 to the wireless access point) including the use of contiguous sub-carriers as in Single Carrier-Frequency Domain Multiple Access (SC-FDMA) in the uplink (e.g., from the wireless access point to the satellite) or the downlink (e.g., from the satellite to the wireless access point). The scheduling is typically performed independently for each subcarrier in accordance with signal-to-noise ratio for a set of frequencies. In one example, the downlink and uplink channels can be divided into a number of frames. Each frame is composed of a set of subframes, each subframe comprises a set of slots, and each slot can comprise a set of resource blocks. A resource block is a basic unit used to schedule transmissions over the satellite backhaul links. Based on data received from the traffic determination component 304, the QoS determination component 306, and/or a channel quality report (e.g., Channel quality indicator (CQI) received from the wireless access points), the scheduling component 302 can determine resource assignments for downlink and/or uplink data transmission. Typically, resource assignments can be defined in terms of resource blocks and can provide information regarding a size of a transport block and physical layer resources that are to be employed in sending it to the wireless access point or satellite via downlink or uplink satellite transport channels. According to an aspect, a scheduling data transfer component 308 can transfer the resource assignment information to satellite 106 (e.g., via satellite modem 202₃ and antenna 204₃). The scheduling data reception component 310 can receive the resource assignment information and the resource allocation component 312 can utilize the resource assignment information to perform resource allocation of the satellite channels. In one aspect, the resource allocation component 312 can broadcast the resource assignment information to the wireless access points. The wireless access points can analyze the information to determine when to receive and transmit communication data on the downlink and/or uplink satellite transport channels.

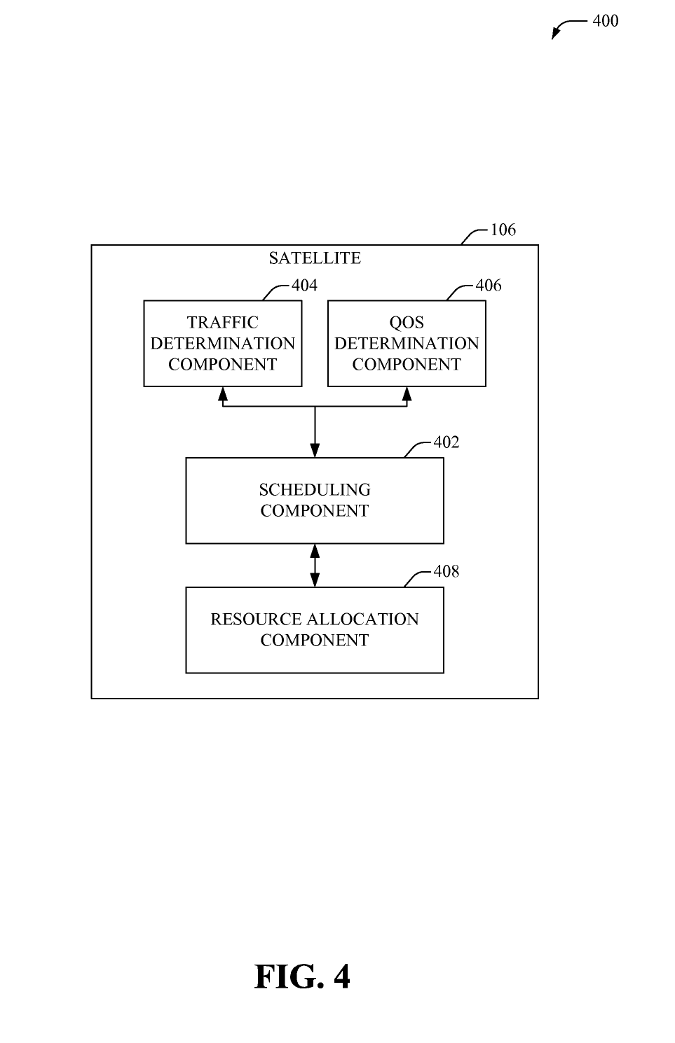

Referring now to FIG. 4, there illustrated is an example system 400, wherein the satellite 106 schedules data transmissions transmitted to/from wireless access points via the satellite backhaul links (e.g., 110₁-110_{N}). The scheduling component 402, the traffic determination component 404, the QoS determination component 406, and the resource allocation component 408 can be can be substantially similar to scheduling component 302, the traffic determination component 304, the QoS determination component 306, and the resource allocation component 312, respectively, and can include respective functionality as more fully described herein, for example, as described above with regard to system 300. Moreover, it can be noted that the scheduling of the satellite backhaul channels can be performed (partially or completely) within most any network device.

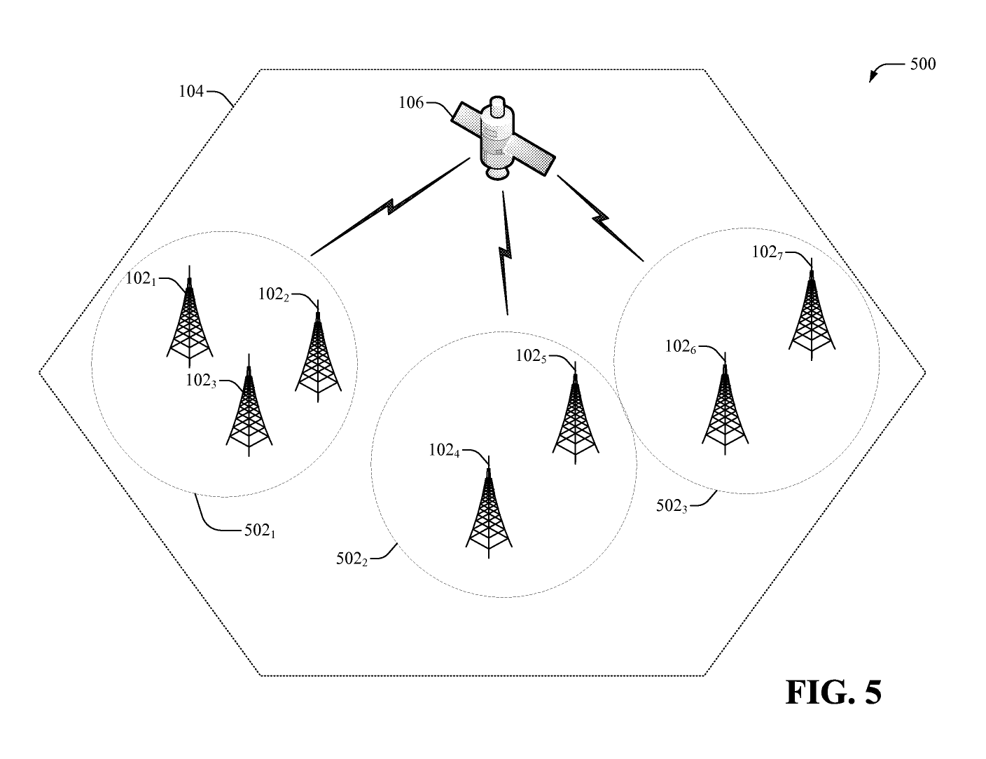

FIG. 5 illustrates an example system 500 that is utilized to increase capacity and spectral efficiency of a satellite backhaul channel, according to an aspect of the subject disclosure. Typically, satellites utilize broad beams that cover a large area, such as an entire continent. However, in one aspect, satellite 106 can utilize spot beams (502₁-502₃) to increase bandwidth and improve spectral efficiency. A spot beam comprises a signal(s) transmitted by satellite 106 that is concentrated in power (e.g., transmitted by a high-gain antenna of satellite 106) to cover only a limited geographic area (502₁-502₃). Moreover, spot beams can enable satellite 106 to communicate with different wireless access points (102₁-102₇) simultaneously (or substantially simultaneously) using the same frequency. Because satellite 106 has a limited number of frequencies to use, the ability to re-use a frequency for different geographical locations (without interference) can increase the number of channels utilized for communication, since the same frequency can be used in different areas. It is noted that the satellite 106 can include functionality as more fully described herein, for example, as described above with regard to systems 100-400. Further, wireless access points 102₁-102₇ are the substantially similar to wireless access points 102₁-102_{N} and can include functionality as more fully described herein, for example, as described above with regard to systems 100-200.

According to an aspect, satellite 106 can form spot beams (502₁-502₃) by shaping the antenna beam of the satellite 106 into a tighter focus such that signal strength received by the wireless access points (102₁-102₃, 102₄-102₅, and 102₆-102₇) and a frequency range utilized within a beam (502₁-502₃) can be utilized multiple times in different beams to increase capacity. For example, the same frequency can be reused in 502₁ and 502₃. It is noted that the spot beams (502₁-502₃) can be adjacent to each other, overlapping, and/or within a defined distance from each other. Further, fewer or greater number of wireless access points can be served within each spot beam (502₁-502₃). In one aspect, satellite 106 can generate a spot beam (502₁-502₃) by converting an electrical signal into a radio frequency by means of a dipole, e.g., by utilizing two intersecting antennas that vibrate when the electrical signal is passed through them to generate a radio frequency that can then be focused with the aid of a cone and/or dish that is angled inward. Moreover, satellite spectrum is re-used within the region covered by different spot beams (502₁-502₃) to increase total satellite capacity. To reduce interference, neighboring/adjacent beams can employ alternating signal frequencies and polarization simultaneously and/or substantially simultaneously. To further differentiate signals for reducing and/or avoiding interference, different types of polarization and/or orientation of transmissions can be utilized. As an example, a frequency reuse scheme can be selected based on the amount of spectrum available and/or the amount of spectrum serving a given area. The spot size (e.g., coverage area) and/or frequency utilized in the spot can be determined based on various factors, for example, traffic demand in an area covered by the spot.

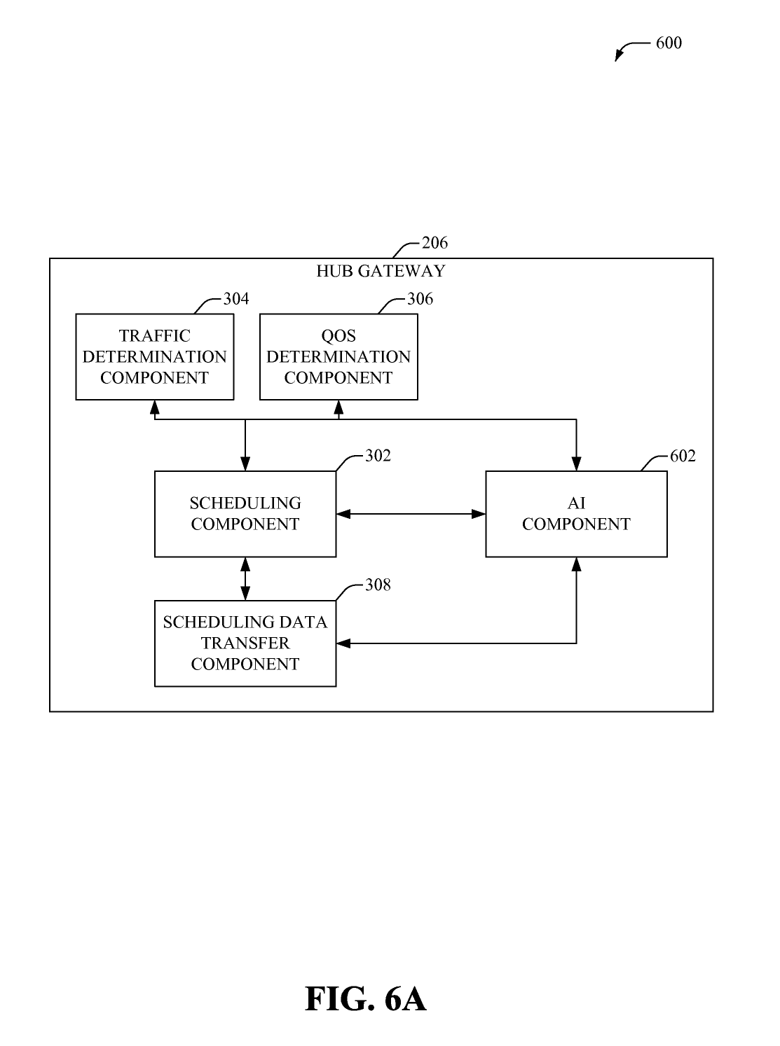

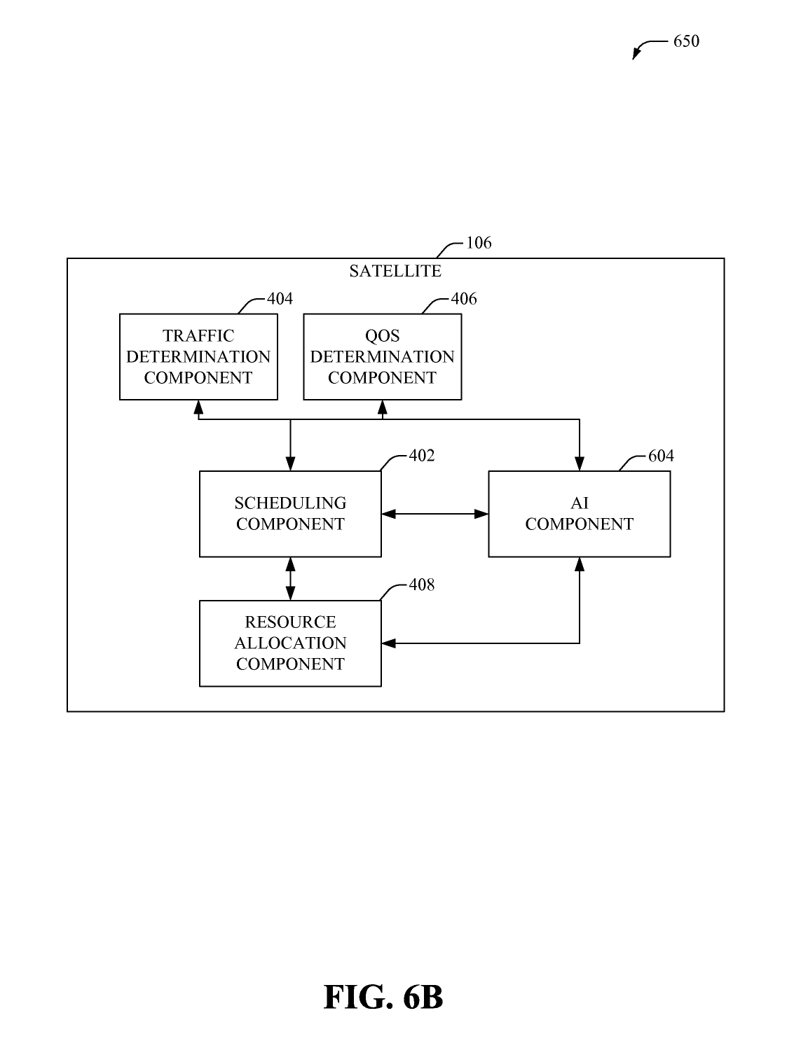

Referring now to FIGS. 6A-6B, there illustrated are example systems 600 and 650 that employ one or more artificial intelligence (AI) components (602, 604), which facilitate automating one or more features in accordance with the subject embodiments. It can be appreciated that the satellite 106, the hub gateway 206, the scheduling components (302, 402), the traffic determination components (304, 404), the QoS determination components (306, 406), scheduling data transfer component 308, and the resource allocation component 408, can include respective functionality, as more fully described herein, for example, with regard to systems 100-500.

In an example embodiment, systems 600 and 650 (e.g., in connection with automatically scheduling a channel between the satellite 106 and a wireless access point (102₁-102_{N})) can employ various AI-based schemes for carrying out various aspects thereof. For example, a process for determining an optimal time/schedule to receive/transmit data, optimal bandwidth/resources allocated to a specific access point, a modulation scheme utilized for transmission, etc. can be facilitated via an automatic classifier system implemented by AI components 602 and/or 604. A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of communication systems, for example, attributes can be information received from UEs and/or wireless access points and/or determined based on metadata or control data associated with communication data, and the classes can be categories or areas of interest (e.g., levels of priorities). A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As will be readily appreciated from the subject specification, an example embodiment can employ classifiers that are explicitly trained (e.g., via a generic training data) as well as implicitly trained (e.g., via observing wireless access point/UE behavior, user/operator preferences or policies, historical information, receiving extrinsic, type of access point (e.g., femto, macro, pico) etc.). For example, SVMs can be configured via a learning or training phase within a classifier constructor and feature selection module. Thus, the classifier(s) of AI component 602 can be used to automatically learn and perform a number of functions, including but not limited to determining according to a predetermined criteria when to allocate bandwidth/resources to a specific access point, an amount of bandwidth/resources that are to be allocated to the specific access point during a specific time period, an optimal time/schedule to receive/transmit data via the satellite links, a modulation scheme utilized for transmission of data via the satellite links, etc. The criteria can include, but is not limited to, historical patterns and/or trends, user preferences, service provider preferences and/or policies, location of the access point, current time, access preferences (e.g., public or private) of the wireless access point, network load/traffic, QoS of the data communicated via the satellite links, and the like.

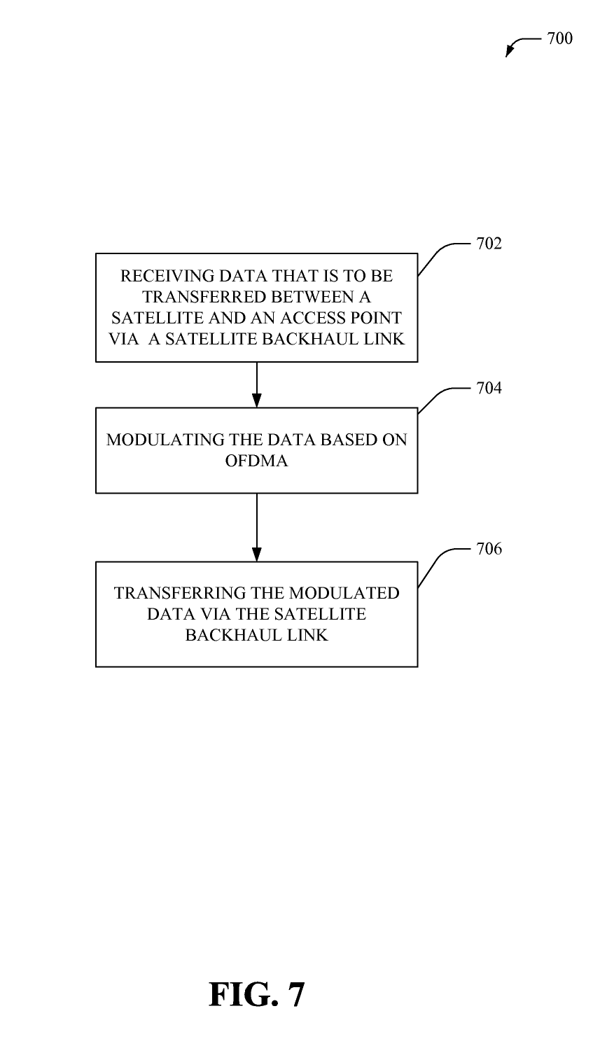

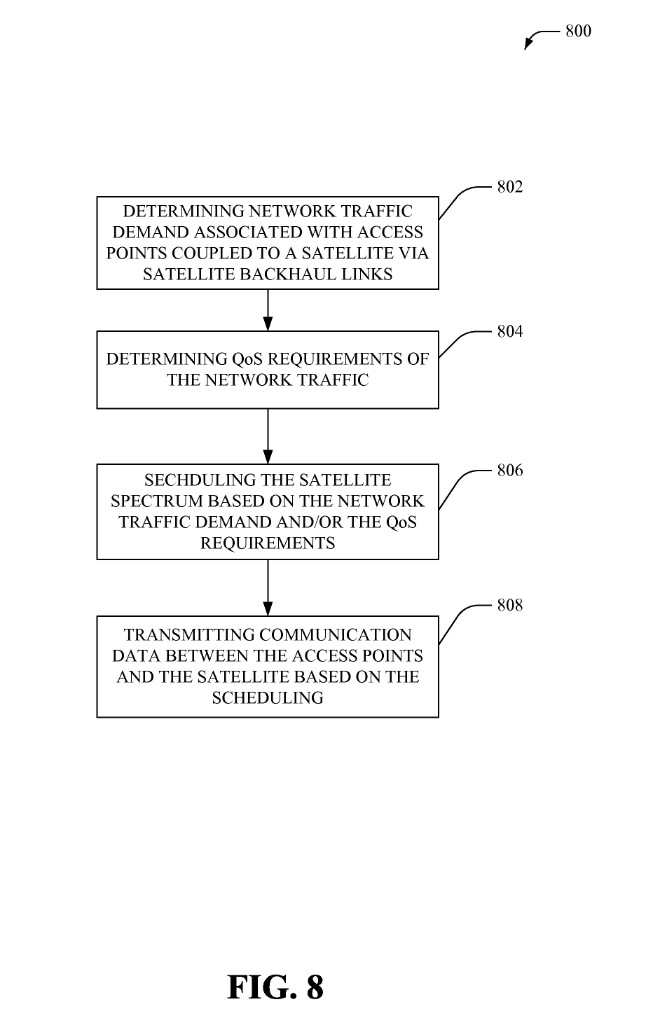

FIGS. 7-8 illustrate flow diagrams and/or methods in accordance with the disclosed subject matter. For simplicity of explanation, the flow diagrams and/or methods are depicted and described as a series of acts. It is to be understood and appreciated that the various embodiments are not limited by the acts illustrated and/or by the order of acts, for example acts can occur in various orders and/or concurrently, and with other acts not presented and described herein. Furthermore, not all illustrated acts may be required to implement the flow diagrams and/or methods in accordance with the disclosed subject matter. In addition, those skilled in the art will understand and appreciate that the methods could alternatively be represented as a series of interrelated states via a state diagram or events. Additionally, it should be further appreciated that the methods disclosed hereinafter and throughout this specification are capable of being stored on an article of manufacture to facilitate transporting and transferring such methods to computers. The term article of manufacture, as used herein, is intended to encompass a computer program accessible from any computer-readable device or computer-readable storage/communications media.

Referring now to FIG. 7, illustrated is an example method 700 for modulating a signal transmitted between a satellite and one or more wireless access points, according to an aspect of the subject disclosure. As an example, method 700 can be implemented by a satellite and/or one or more network devices of a radio access network (RAN), for example, an eNB, HNB, HeNB, etc. In another example, method 700 can be implemented (at least partially) by one or more devices of a core mobility network (e.g., a hub gateway). In one aspect, the wireless access point utilizes a satellite backhaul link that facilitates transfer of data between the wireless access point (and/or a UE coupled to the access point) and a core network device via the satellite. At 702, data that is to be transferred between the satellite and a wireless access point via the satellite backhaul link can be received. As an example, the data can include packetized communication data utilized for VoIP, Internet/broadband access, and/or most any IP services. At 704, the data is multiplexed/modulated based on OFDMA. In one example, OFDMA is utilized to provide sub-carriers for the modulation (demodulation) to increase efficiency of the satellite spectrum. Additionally or optionally, OFDMA can be utilized in conjunction with advanced antenna techniques and adaptive modulation and coding methods to achieve significant throughput and satellite spectral efficiency improvements. The increased satellite spectral efficiency facilitates transfer of data at a higher rate, resulting in a lower cost-per-bit. Further, at 706, the modulated signal can be transferred via the satellite backhaul link.

FIG. 8 illustrates an example method 800 that facilitates scheduling satellite links between a satellite and a set of wireless access points, according to an aspect of the subject disclosure. As an example, method 800 can be implemented by a satellite. In another example, method 800 can be implemented (at least partially) by one or more devices of a core mobility network (e.g., a hub gateway). At 802, network traffic demand associated with access points coupled to the satellite via satellite backhaul links can be determined. For example, an amount of traffic requested by each wireless access point can be determined based on control signaling received from the wireless access points. At 804, QoS requirements of the network traffic can be determined. In one example, the QoS associated with the network traffic can be determined based on a QCI that provides information regarding priority and/or type of service. For instance, traffic associated with real-time communication (e.g., video calls, interactive gaming, etc.) can be assigned a higher QoS priority than that assigned to traffic associated with non real-time communication (e.g., email, messaging, etc.). Further, a higher QoS priority can be assigned to network traffic associated with a UE (and/or femto access point) of a subscriber that has paid a higher fee to obtain a higher QoS. In another example, the satellite channel quality, which can be adversely affected by prevailing atmospheric conditions, can also be factored in the scheduler resource assignment to satisfy the required QoS.

At 806, the satellite spectrum is scheduled based on the network traffic demand, and/or channel condition/quality report (CQR), and/or the QoS requirements. Further, at 808, communication data can be transmitted between the wireless access points and the satellite based on the scheduling. As an example, a greater amount of resources (e.g., bandwidth/spectrum, time slot, etc.) can be allocated to a wireless access point that is determined to be transmitting/receiving greater amount of data, while fewer resources (e.g., bandwidth/spectrum, time slot, etc.) to another wireless access point that is determined to be transmitting/receiving less amount of data. Additionally or alternatively, a greater amount of resources (e.g., bandwidth/spectrum, time slot, etc.) can be allocated to a data flow that has a higher QoS priority than a data flow that has a lower QoS priority.

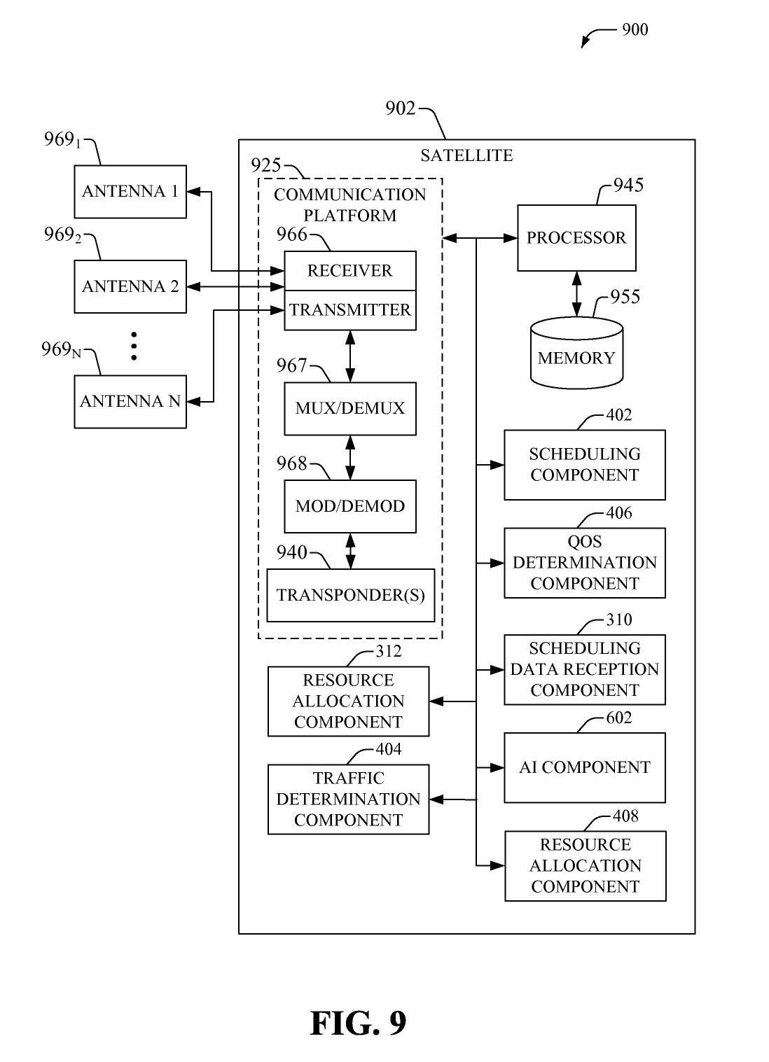

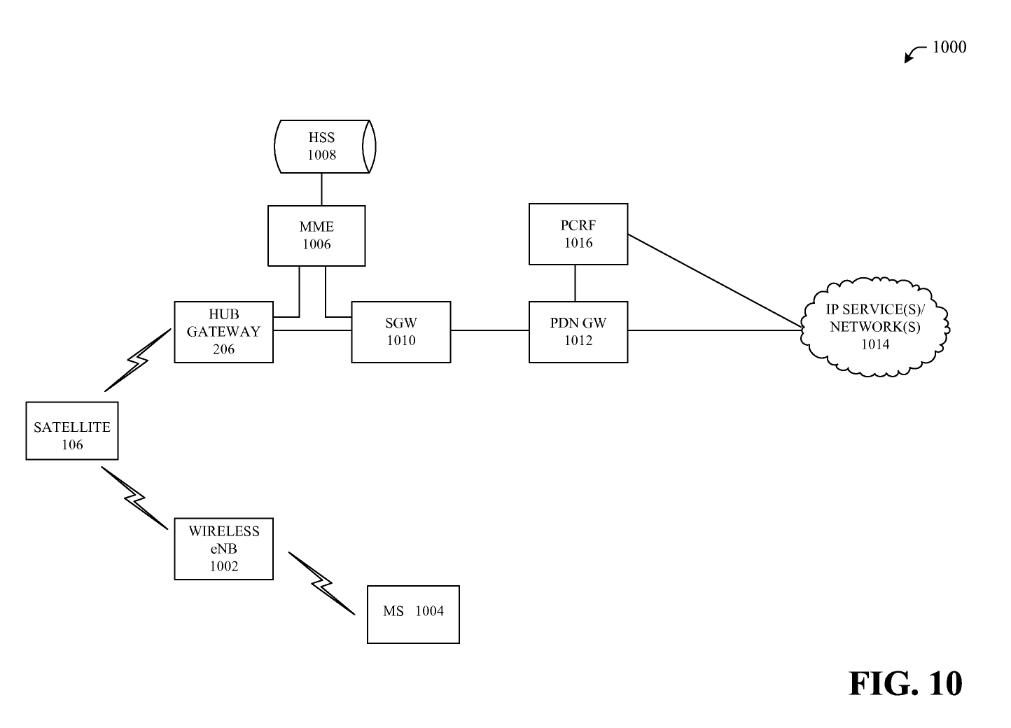

To provide further context for various aspects of the subject specification, FIGS. 9 and 10 illustrate, respectively, a block diagram of an example embodiment 900 of a satellite that facilitates scheduling and/or modulating signals transmitted via wireless backhaul links and a wireless communication environment 1000, with associated components for operation of packet access for cellular backhaul of wireless access points via satellite links with aspects described herein.

With respect to FIG. 9, in example embodiment 900 comprises a satellite 902. As an example, the satellite 106 disclosed herein with respect to systems 100-500 and 650 can include at least a portion of the satellite 902. In one aspect, the satellite 902 can receive and transmit signal(s) (e.g., traffic and control signals) from and to wireless access points and/or hub gateways, etc., through a set of antennas 969₁-969_{N}. It should be appreciated that while antennas 969₁-969_{N} are a part of communication platform 925, which comprises electronic components and associated circuitry that provides for processing and manipulating of received signal(s) (e.g., a packet flow) and signal(s) (e.g., a broadcast control channel) to be transmitted. In an aspect, communication platform 925 can include a transmitter/receiver (e.g., a transceiver) 966 that can convert signal(s) from analog format to digital format (e.g., analog-to-digital conversion) upon reception, and from digital format to analog (e.g., digital-to-analog conversion) format upon transmission. In addition, receiver/transmitter 966 can divide a single data stream into multiple, parallel data streams, or perform the reciprocal operation. Coupled to transceiver 966 is a multiplexer/demultiplexer 967 that facilitates manipulation of signal in time and/or frequency space. Electronic component 967 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM), etc. In addition, mux/demux component 967 can scramble and spread information (e.g., codes) according to substantially any code known in the art; e.g., Hadamard-Walsh codes, Baker codes, Kasami codes, polyphase codes, and so on. A modulator/demodulator 968 is also a part of operational group 925, and can modulate information according to multiple modulation techniques, such as OFDMA, frequency modulation, amplitude modulation (e.g., M-ary quadrature amplitude modulation (QAM), with M a positive integer), phase-shift keying (PSK), and the like. Further, the communication platform 925 can include a transponder(s) 940 that are utilized to transfer received signals. In one example, the transponder(s) 940 can include an input filter (e.g., a band pass filter), an input amplifier (e.g., a low-noise amplifier (LNA)) that amplifies weak input signals received from a set of the antennas 969₁-969_{N}, a frequency translator (e.g., including an oscillator and a frequency mixer) used to convert the uplink frequency to a downlink frequency, an output filter (e.g., a band pass filter), and an output amplifier (e.g., a power amplifier) that amplifies output signals that are to be transmitted by a set of the antennas 969₁-969_{N}.

Satellite 902 also includes a processor 945 configured to confer functionality, at least partially, to substantially any electronic component in the satellite 902, in accordance with aspects of the subject disclosure. In particular, processor 945 can facilitates implementing configuration instructions received through communication platform 925, which can include storing data in memory 955. In addition, processor 945 facilitates processing data (e.g., symbols, bits, or chips, etc.) for multiplexing/demultiplexing, such as effecting direct and inverse fast Fourier transforms (IFFT/FFT), selection of modulation rates, selection of data packet formats, inter-packet times, scheduling traffic via the satellite links, etc. Moreover, processor 945 can manipulate antennas 969₁-969_{N} to facilitate beamforming or selective radiation pattern formation, which can benefit specific locations covered by the satellite 902; and exploit substantially any other advantages associated with smart-antenna technology. Memory 955 can store data structures, code instructions, system or device information like device identification codes (e.g., access point cell identifiers (ID), International Mobile Station Equipment Identity (IMEI), Mobile Station International Subscriber Directory Number (MSISDN), serial number . . . ) and specification such as multimode capabilities; code sequences for scrambling; spreading and pilot transmission, floor plan configuration, access point deployment and frequency plans; and so on. Moreover, memory 955 can store configuration information such as schedules and policies; geographical indicator(s); cell-type data and/or cell profile data (e.g., of wireless access points 102₁-102_{N}), scheduling data, traffic and/or QoS data, historical logs, and so forth.

In embodiment 900, processor 945 can be coupled to the memory 955 in order to store and retrieve information necessary to operate and/or confer functionality to communication platform 925, and other operational components (e.g., multimode chipset(s), power supply sources, solar panels, etc.; not shown) that support the satellite 902. The satellite 902 can further include a scheduling data reception component 310, a resource allocation component 312, a scheduling component 402, a traffic determination component 404, a QoS determination component 406, resource allocation component 408 and/or an AI component 602 which can include functionality, as more fully described herein, for example, with regard to systems 100-400 and 650. In addition, it is to be noted that the various aspects disclosed in the subject specification can also be implemented through (i) program modules stored in a computer-readable storage medium or memory (e.g., memory 955) and executed by a processor (e.g., processor 945), or (ii) other combination(s) of hardware and software, or hardware and firmware.

FIG. 10 illustrates a high-level block diagram that depicts an example LTE network architecture 1000 that can employ the disclosed communication architecture. Satellite 106 and hub gateway 206 can include functionality as more fully described herein, for example, as described above with regard to systems 100-650 and 900.

The evolved RAN for LTE consists of an eNodeB (eNB) 1002 that can facilitate connection of MS 1004 to an evolved packet core (EPC) network. In one aspect, the MS 1104 is physical equipment or Mobile Equipment (ME), such as a mobile phone or a laptop computer that is used by mobile subscribers, with a Subscriber identity Module (SIM). The SIM includes an International Mobile Subscriber Identity (IMSI) and/or MSISDN, which is a unique identifier of a subscriber. The MS 1004 includes an embedded client that receives and processes messages received by the MS 1004. As an example, the embedded client can be implemented in JAVA. It is noted that MS 1004 can be substantially similar to UEs 114₁-114₄, and can include functionality described with respect to 114₁-114₄ in systems 100-200. Further, eNB 1002 can be substantially similar to wireless access points 102₁-102_{N}, and can include functionality described with respect to 114₁-114_{N} in systems 100-200 and 500.

The connection of the MS 1004 to the evolved packet core (EPC) network is subsequent to an authentication, for example, a SIM-based authentication between the MS 1004 and the evolved packet core (EPC) network. In one aspect, the MME 1006 provides authentication of the MS 1004 by interacting with the HSS 1008. The HSS 1008 contains a subscriber profile and keeps track of which core network node is currently handling the subscriber. It also supports subscriber authentication and authorization functions (AAA). In networks with more than one HSS 1008, a subscriber location function provides information on the HSS 1008 that contains the profile of a given subscriber.

As an example, the eNB 1002 can host a PHYsical (PHY), Medium Access Control (MAC), Radio Link Control (RLC), and Packet Data Control Protocol (PDCP) layers that include the functionality of user-plane header-compression and encryption. In addition, the eNB 1002 can implement at least in part Radio Resource Control (RRC) functionality (e.g., radio resource management, admission control, scheduling, cell information broadcast, etc.). The eNB 1002 can be coupled to a serving gateway (SGW) 1010 that facilitates routing of user data packets and serves as a local mobility anchor for data bearers when the MS 1004 moves between eNBs. In one aspect, eNB 1002 is coupled to the SGW 1010 via satellite backhaul links through satellite 106 and hub gateway 206.

The SGW 1010 can act as an anchor for mobility between LTE and other 3GPP technologies (GPRS, UMTS, etc.). When MS 1004 is in an idle state, the SGW 1010 terminates a downlink (DL) data path and triggers paging when DL data arrives for the MS 1004. Further, the SGW 1010 can perform various administrative functions in the visited network such as collecting information for charging and lawful interception. In one aspect, the SGW 1010 can be coupled to a Packet Data Network Gateway (PDN GW) 1012 that provides connectivity between the MS 1004 and external packet data networks such as IP service(s)/network(s) 1014. Moreover, the PDN GW 1012 is a point of exit and entry of traffic for the MS 1004. It is noted that the MS 1004 can have simultaneous connectivity with more than one PDN GW (not shown) for accessing multiple PDNs.

The PDN GW 1012 performs IP address allocation for the MS 1004, as well as QoS enforcement and implements flow-based charging according to rules from a Policy Control and Charging Rules Function (PCRF) 1016. The PCRF 1016 can facilitate policy control decision-making and control flow-based charging functionalities in a Policy Control Enforcement Function (PCEF), which resides in the PDN GW 1012. The PCRF 1016 can store data (e.g., QoS class identifier and/or bit rates) that facilitates QoS authorization of data flows within the PCEF. In one aspect, the PDN GW 1012 can facilitate filtering of downlink user IP packets into the different QoS-based bearers and perform policy enforcement, packet filtering for each user, charging support, lawful interception and packet screening. Further, the PDN GW acts as the anchor for mobility between 3GPP and non-3GPP technologies such as WiMAX and 3GPP2 (CDMA 1× and EvDO). Although an LTE network architecture 1000 is described and illustrated herein, it is noted that most any communication network architecture can be utilized to implement the disclosed embodiments.

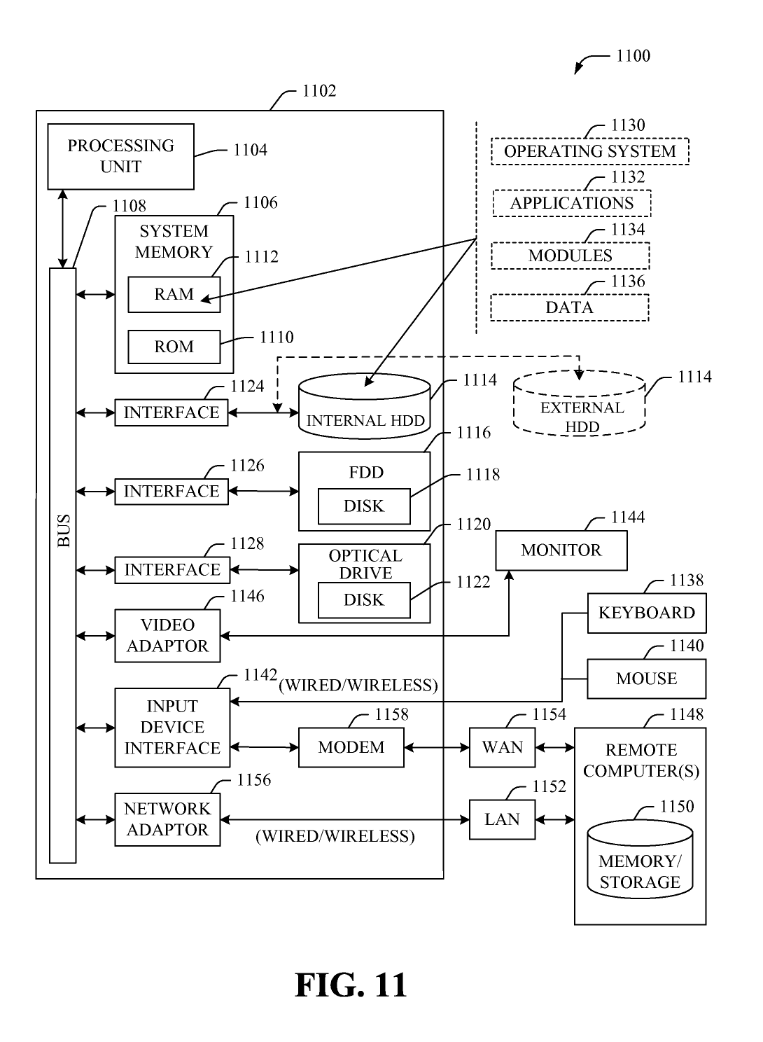

Referring now to FIG. 11, there is illustrated a block diagram of a computer 1102 operable to execute the disclosed communication architecture. In order to provide additional context for various aspects of the disclosed subject matter, FIG. 11 and the following discussion are intended to provide a brief, general description of a suitable computing environment 1100 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, radio frequency (RF), infrared and other wireless media.

With reference again to FIG. 11, the example environment 1100 for implementing various aspects of the specification includes a computer 1102, the computer 1102 including a processing unit 1104, a system memory 1106 and a system bus 1108. As an example, the component(s), server(s), equipment, system(s), and/or device(s) (e.g., wireless access point 102₁-102_{N}, satellite 106, UEs 114₁-114₄, satellite modem 202₁-202₃, antennas 204₁-204₂, hub gateway 206, access point 212, scheduling component 302, traffic determination component 304, QoS determination component 306, scheduling data transfer component 308, scheduling data reception component 310, resource allocation component 312, scheduling component 402, traffic determination component 404, QoS determination component 406, resource allocation component 408, AI component 602, AI component 604, satellite 902, wireless eNB 1002, MS 1004, MME 1006, HSS 1008, SGW 1010, PDN GW 1012, PCRF 1016, etc.) disclosed herein with respect to system 100-650 and 900-1000 can each include at least a portion of the computer 1102. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114, which internal hard disk drive 1114 can also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject disclosure.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to a HDD, a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods of the specification.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the specification can be implemented with various commercially available operating systems or combinations of operating systems.

A user can enter commands and information into the computer 1102 through one or more wired/wireless input devices, e.g., a keyboard 1138 and/or a pointing device, such as a mouse 1140 or a touchscreen or touchpad (not illustrated, but which may be integrated into UE 114₁-114₄ in some embodiments). These and other input devices are often connected to the processing unit 1104 through an input device interface 1142 that is coupled to the system bus 1108, but can be connected by other interfaces, such as a parallel port, an IEEE 1394 serial port, a game port, a USB port, an infrared (IR) interface, etc. A monitor 1144 or other type of display device is also connected to the system bus 1108 via an interface, such as a video adapter 1146.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 is connected to the local network 1152 through a wired and/or wireless communication network interface or adapter 1156. The adapter 1156 can facilitate wired or wireless communication to the LAN 1152, which can also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are example and other means of establishing a communications link between the computers can be used.

The computer 1102 is operable to communicate with any wireless devices or entities operatively disposed in wireless communication, e.g., desktop and/or portable computer, server, communications satellite, etc. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11 (a, b, g, n, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 5 GHz radio band at an 54 Mbps (802.11a) data rate, and/or a 2.4 GHz radio band at an 11 Mbps (802.11b), an 54 Mbps (802.11g) data rate, or up to an 600 Mbps (802.11n) data rate for example, or with products that contain both bands (dual band), so the networks can provide real-world performance similar to the basic 10BaseT wired Ethernet networks used in many offices.

As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
determining traffic data associated with data packets that are to be transmitted between a satellite device and wireless access point devices via a wireless backhaul link, wherein the wireless access point devices are deployed within a coverage area of the satellite device, and
based on the traffic data, assigning satellite channels of the wireless backhaul link to the wireless access point devices to facilitate communication of the data packets.

2. The system of claim 1, wherein the traffic data comprises demand data representing an amount of information requested by a wireless access point device of the wireless access point devices.

3. The system of claim 2, wherein the demand data is determined based on control data received from the wireless access point device.

4. The system of claim 3, wherein the control data comprises a buffer status report representing data stored within a buffer associated with the wireless access point device.

5. The system of claim 2, wherein the amount of information is a first amount of first information, the wireless access point device is a first wireless access point device and the assigning comprises,
in response to determining that the first amount of first information is greater than a second amount of second information requested by a second wireless access point device of the wireless access point devices, assigning a first set of the satellite channels to the first wireless access point device and a second set of the satellite channels to the second wireless access point device, and wherein the first set is greater than the second set.

6. The system of claim 1, wherein the traffic data comprises classification data indicative of a quality of service assigned to a set of the data packets.

7. The system of claim 6, wherein the quality of service is a first quality of service, the set of the data packets is a first set of the data packets, and the assigning comprises,
in response to determining that the first quality of service has a higher rank than a second quality of service that is assigned to a second set of the data packets, assigning a first set of the satellite channels for a first transfer of the first set of the data packets and a second set of the satellite channels for a second transfer of the second set of the data packets, and wherein the first set of the satellite channels is greater than the second set of the satellite channels.

8. The system of claim 1, wherein the operations further comprise:
employing an orthogonal frequency division multiple access process to facilitate the communication.

9. The system of claim 1, wherein the data packets are transmitted between the wireless access point devices and the satellite device via a generic routing encapsulation protocol.

10. The system of claim 1, wherein the data packets are directed to a set of user equipment coupled to the wireless access point devices.

11. A method, comprising:
determining, by a system comprising a processor, traffic demand data associated with wireless access point devices that are coupled to a network device via a satellite device; and
based on the traffic demand data, scheduling, by the system, a satellite spectrum of the satellite device to facilitate a transfer of data packets between the wireless access point devices and the satellite device.

12. The method of claim 11, further comprising:
based on the scheduling, facilitating, by the system, the transfer via a satellite channel.

13. The method of claim 12, wherein the facilitating comprises modulating a signal comprising the data packets based on an orthogonal frequency division multiple access modulation process.

14. The method of claim 11, wherein the scheduling comprises scheduling the satellite spectrum based on quality of service data assigned to the data packets.

15. The method of claim 11, the scheduling comprises scheduling the satellite spectrum based on channel quality data received from a wireless access point device of the wireless access point devices, wherein the channel quality data represents a quality of a satellite-to-access point link between the satellite device and the wireless access point device.

16. The method of claim 15, wherein the receiving comprises receiving report data indicative of a status of a buffer associated with a wireless access point device of the wireless access point devices.

17. A computer-readable storage device comprising executable instructions that, in response to execution, cause a satellite device comprising a processor to perform operations, comprising:
determining traffic demand data associated with wireless access point devices that are coupled to a network device via the satellite device; and
based on the traffic demand data, allocating, to the wireless access point devices, satellite channels of a wireless backhaul link that couples the satellite device to the wireless access point devices, to facilitate a transfer of data packets via the wireless backhaul link.

18. The computer-readable storage device of claim 17, wherein the determining the traffic demand data comprises determining the traffic demand data based on control data received from the wireless access point devices.

19. The computer-readable storage device of claim 17, wherein the allocating comprises allocating the satellite channels based on quality of service data assigned to the data packets.

20. The computer-readable storage device of claim 17, wherein the data packets are transferred via the wireless backhaul link subsequent to an orthogonal frequency division multiple access modulation of a signal representing the data packets.
